(19) United States
(12) Patent Application Publication
(10) Pub. No.: US 2024/0358199 A1
(43) Pub. Date: Oct. 31, 2024

(54) DEMOULDING DEVICE AND COOKING DEVICE

(71) Applicant: Tsann Kuen (Zhangzhou) Enterprise Co., Ltd., Zhangzhou (CN)

(72) Inventors: Chunyu WU, Zhangzhou (CN); Guanwen HE, Zhangzhou (CN)

(21) Appl. No.: 18/607,493

(22) Filed: Mar. 17, 2024

(30) Foreign Application Priority Data
Apr. 26, 2023 (CN) 202320976749.4

(51) Int. Cl. A47J 43/20; A47J 37/10

(52) U.S. Cl. CPC A47J 43/20; A47J 37/108

(57) ABSTRACT

A demoulding device configured for releasing a cooked food comprises a releasing frame and a cooking container. The releasing frame comprises a top end, a bottom end, and a hollow column extending downward from the bottom end and penetrating through the releasing frame in a vertical direction. The cooking container comprises a container sidewall, and the container sidewall comprises an abutted portion which the releasing frame is configured to abut. When the releasing frame abuts the abutted portion, a bottommost part of the hollow column is higher than a bottommost part of the cooking container.

### RELATED APPLICATIONS

This application claims priority to Chinese patent application number 202320976749.4, filed on Apr. 26, 2023. Chinese patent application number 202320976749.4 is incorporated herein by reference.

### FIELD OF THE DISCLOSURE

The present disclosure relates to a food cooking device, and in particular to a food cooking device with a demoulding device.

### BACKGROUND OF THE DISCLOSURE

Food contained and cooked in a container is difficult to separate from the container when part of the food is adheres to a container inner wall. In order to solve this problem, Chinese patent application CN211211166U provides a bottom bracket disposed on a bottom of a frying and roasting tray and used to release the food on the frying and roasting tray, but the bottom bracket needs to be flipped upside-down to shake off the food from the container. A shape of a bottom of the food is damaged easily under such operation. An overall shape of the food also can be warped due to shaking off the food from the container, and in a process for carrying the bottom bracket containing the food to a table, the food can easily fall from the bottom bracket because of user's improper operation at any time.

### BRIEF SUMMARY OF THE DISCLOSURE

The present disclosure provides a demoulding device and cooking device to solve the deficiencies in the background.

In order to solve the technical problem, a first technical solution of the present disclosure is as follows.

A demoulding device configured for releasing a cooked food comprises a releasing frame and a cooking container. The releasing frame comprises a top end, a bottom end, and a hollow column extending downward from the bottom end and penetrating through the releasing frame in a vertical direction. The cooking container comprises a container sidewall, and the container sidewall comprises an abutted portion which the releasing frame is configured to abut. When the releasing frame abuts the abutted portion, a bottommost part of the hollow column is higher than a bottommost part of the cooking container.

In a preferred embodiment, a cross-sectional area of the hollow column gradually decreases in a direction from the top end of the releasing frame to the bottom end of the releasing frame.

In a preferred embodiment, a side wall of the hollow column is inclined gradually inward from the top end of the releasing frame to the bottom end of the releasing frame.

In a preferred embodiment, the hollow column has a flange extending outward from a side wall of the hollow column at the top end.

In a preferred embodiment, the releasing frame has a handle.

In a preferred embodiment, a bottom surface of the flange is configured to abut a top wall of the cooking container.

In a preferred embodiment, the hollow column of the releasing frame is a hollow truncated cone structure.

In a preferred embodiment, the abutted portion of the cooking container is a recess.

In a preferred embodiment, a height of the hollow column is h, a depth of the cooking container is A, and a range of h is ⅓A≤h≤⅔A.

A cooking device comprises the demoulding device, and the cooking container is a frying and roasting tray.

Compared with the existing techniques, the technical solution has the following advantages.

The cooking container receives the releasing frame to form the cooking cavity. At this time, the bottommost part of the hollow column is higher than the bottommost part of the cooking container. When cooking, the batter is poured into the cooking cavity, and a bottommost of the batter is in contact with the bottommost part of the cooking cavity. It can be understand that the bottommost part of the hollow column is also higher than the bottommost part of the cooked food. When the cooking process is complete, the releasing frame holding the cooked food can be taken out of the cooking container to be placed on a plane, and the user can press down the releasing frame to rapidly separate the releasing frame from the cooked food without damaging a shape of the cooked food. When taking the cooked food out, the cooked food is fixedly connected to the releasing frame by the hollow column, and the cooked food will not shake off even if the user operates improperly.

### BRIEF DESCRIPTION OF THE DRAWINGS

FIG. 1 illustrates a perspective view of a releasing frame and a cooking container, illustrating a correspondence of the releasing frame to the cooking container.

FIG. 2 illustrates a top view of the releasing frame and the cooking container of FIG. 1 assembled into a demoulding device.

FIG. 3 illustrates a cross-sectional view taken along line A-A of FIG. 2, illustrating the correspondence of the releasing frame to the cooking container.

FIG. 4 illustrates a cross-sectional view of the releasing frame, illustrating a structure of the releasing frame.

FIG. 5 illustrates a cross-sectional view of the cooking container, illustrating a structure of the cooking container.

FIG. 6 illustrates a perspective view of the releasing frame containing cooked food.

FIG. 7 illustrates a cross-sectional view of the demoulding device containing the cooked food.

FIG. 8 illustrates a cross-sectional view illustrating a releasing frame containing the cooked food.

FIG. 9 illustrates a cross-sectional view of the releasing frame and the cooked food, illustrating the cooked food separated from the releasing frame.

FIG. 10 illustrates a perspective view illustrating a cooking device, which is a frying and roasting device.

FIG. 11 illustrates a perspective view illustrating a cooking device, which is an oven.

### DETAILED DESCRIPTION OF THE EMBODIMENTS

The present disclosure will be further described below in combination with the accompanying drawings and embodiments.

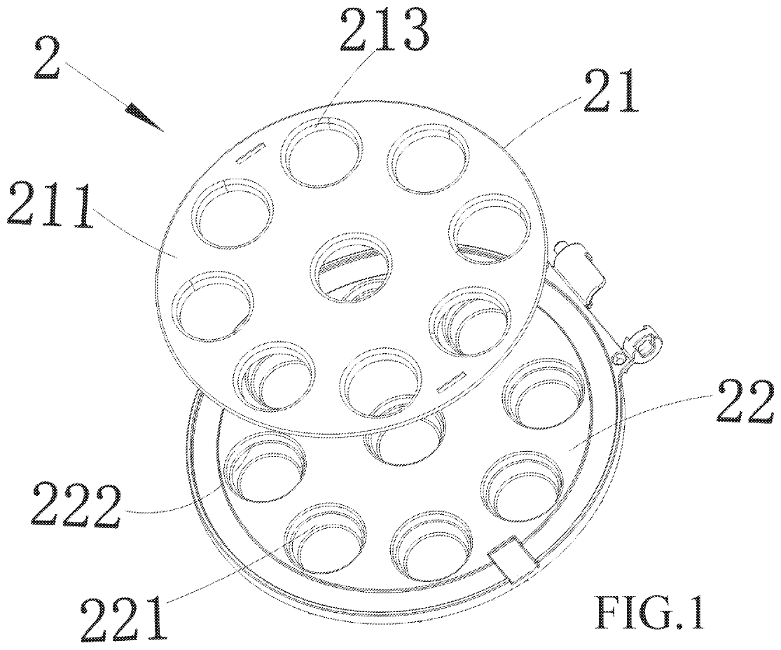

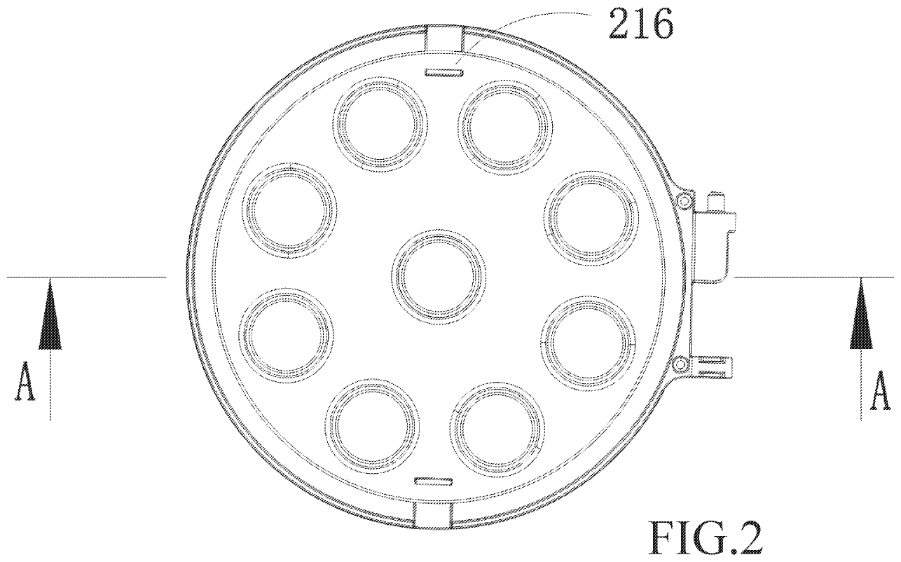

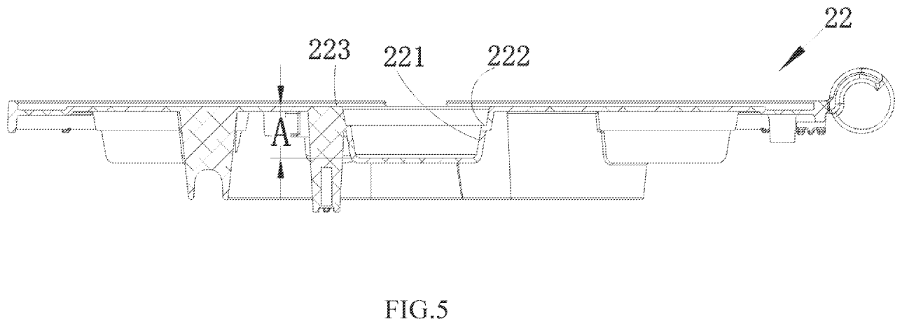

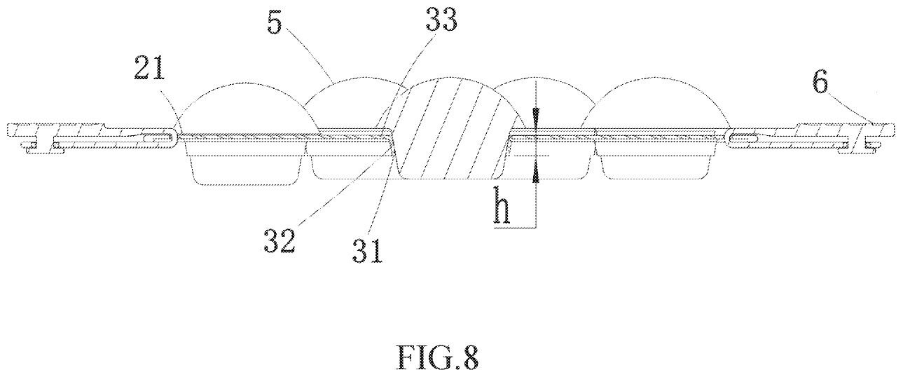

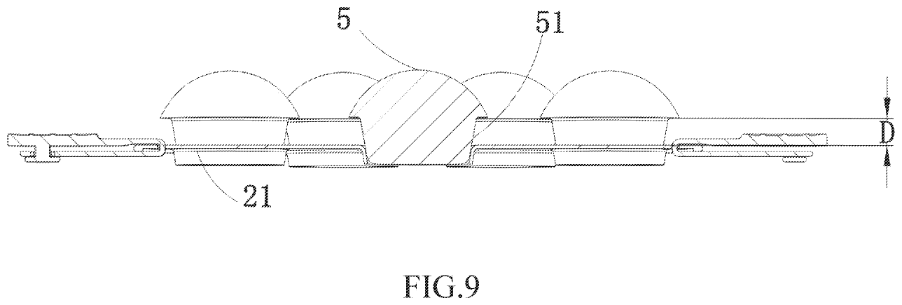

Referring to FIGS. 1 to 9, an embodiment of the present disclosure provides a demoulding device 2 configured for releasing cooked food 5, especially a pastry. The demoulding device 2 comprises a releasing frame 21 and a cooking container 22. The releasing frame 21 comprises a top end 211, a bottom end 212, and a hollow column 3 extending downward from the bottom end 212 and penetrating through the releasing frame 21 in a vertical direction. The cooking container 22 comprises a container sidewall 221, and the container sidewall 221 comprises an abutted portion 222, which the releasing frame 21 is configured to abut. The releasing frame 21 can abut the abutted portion 222 so as to be placed in the cooking container 22. In this embodiment, a bottom surface 31 of the hollow column 3 of the releasing frame 21 abuts the abutted portion 222. A person skilled in the art also is able to achieve the releasing frame 21 abutting the abutted portion 222 by providing a protrusion outside a column sidewall 32 of the hollow column 3. The technical means are numerous and not described in detail herein.

When the releasing frame 21 is placed on the cooking container 22, a cooking cavity 23 is defined, and a bottommost part of the hollow column 3 is higher than a bottommost part of the cooking container 22. It is understood that the bottommost part of the hollow column 3 is also higher than a bottommost part of the cooked food 5. In this embodiment, when a user cooks raw materials of the food (i.e., batter), the batter is poured into the cooking cavity 23, and the batter is heated and expanded to form the cooked food 5. When the user wants to take out the cooked food 5 from the cooking cavity 23, the releasing frame 21 holding the cooked food 5 is separated from the cooking container 22 and is put on a plane, and then the releasing frame 21 is pressed downward, so that the releasing frame 21 is moved downward relative to the cooked food 5 and a quick separation from the cooked food 5 is realized.

Referring to FIGS. 1 to 9, in a preferred embodiment, a cross-sectional area of the hollow column 3 gradually decreases in a direction from the top end 211 of the releasing frame 21 to the bottom end 212 of the releasing frame 21. Due to a shape of the releasing frame 21 and the hollow column 3, a cross-sectional area of the cooked food 5 held on the hollow column 3 also gradually decreases in the direction from the top end 211 of the releasing frame 21 to the bottom end 212 of the releasing frame 21 in a height h of the hollow column 3, so that the cross-sectional area of the cooked food 5 above a bottommost part of the height h is larger than a cross-sectional area of the bottommost part of the hollow column 3. When the releasing frame 21 is taken out from the cooking container 22, the cooked food 5 is supported by the bottom surface 31 of the hollow column 3 under an influence of gravity and is kept in the hollow column 3, so that the cooked food 5 does not easily fall off.

Referring to FIGS. 1 to 9, in a preferred embodiment, the column sidewall 32 of the hollow column 3 is inclined gradually inward from the top end 211 of the releasing frame 21 to the bottom end 212 of the releasing frame 21. A food side wall (not shown) of the cooked food 5 is gradually inclined inward in the direction from the top end 211 of the releasing frame 21 to the bottom end 212 of the releasing frame 21 in the height h of the hollow column 3 due to the shape of the releasing frame 21 and the hollow column 3. When the releasing frame 21 is taken out from the cooking container 22, the cooked food 5 is supported by the bottom surface 31 and the column sidewall 32 of the hollow column 3 under the influence of gravity and is kept in the hollow column 3 of the releasing frame 21, and the cooked food 5 does not easily fall.

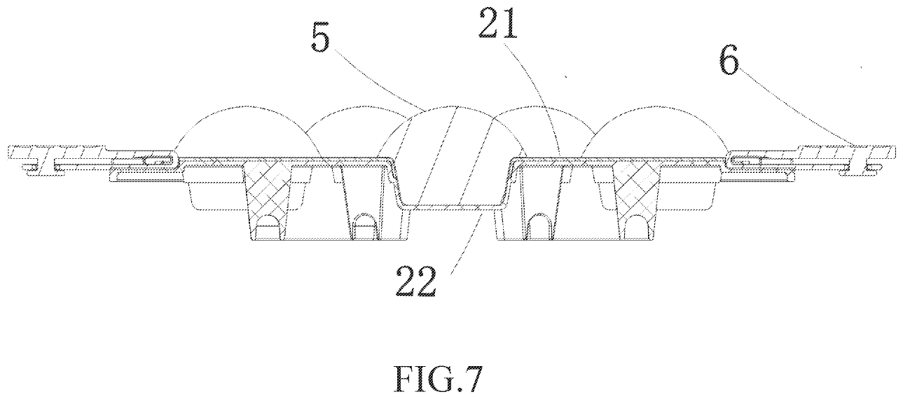

Referring to FIGS. 1 to 9, in a preferred embodiment, the hollow column 3 has a flange 33 extending outward from the column sidewall 32 at the top end 211. When the releasing frame 21 abuts the abutted portion 222 of the cooking container 22, a bottom surface 331 of the flange 33 abuts a top wall 223 of the cooking container 22. When the user pours more batter during a cooking process, the batter is cooked and expands to an outside of the cooking cavity 23, that is, to an upper side of the flange 33, as shown in FIG. 7, and the cooked food 5 has a mushroom shape. Therefore, when the releasing frame 21 is taken out of the cooking container 22, the cooked food 5 is supported by the bottom surface 31, the column sidewall 32, and the flange 33 of the hollow column 3 under the influence of gravity, and the cooked food 5 is kept in the hollow column 3 of the releasing frame 21, so that the cooked food 5 is more stable in a moving process.

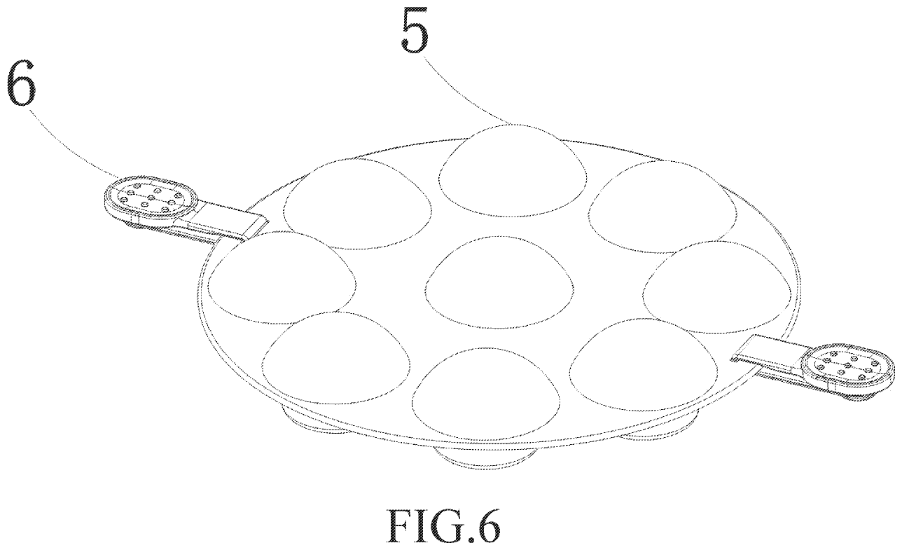

Referring to FIGS. 1 and 6, in a preferred embodiment, the releasing frame 21 has a handle 6, and the user can grasp the handle 6 to more conveniently remove the releasing frame 21 from the cooking container 22. A connection mode of the handle 6 and the releasing frame 21 has various forms. For example, the handle 6 is made of silicon rubber, the handle 6 is in a strip shape, the handle 6 can pass through a through hole 216 arranged at an edge of the releasing frame 21, and the handle 6 is buckled together in an end-to-end form and is connected to the releasing frame 21. For example, the handle 6 and the releasing frame 21 can be in an integrated structure, and the handle 6 is arranged at an outer edge of the releasing frame 21 and extends outward.

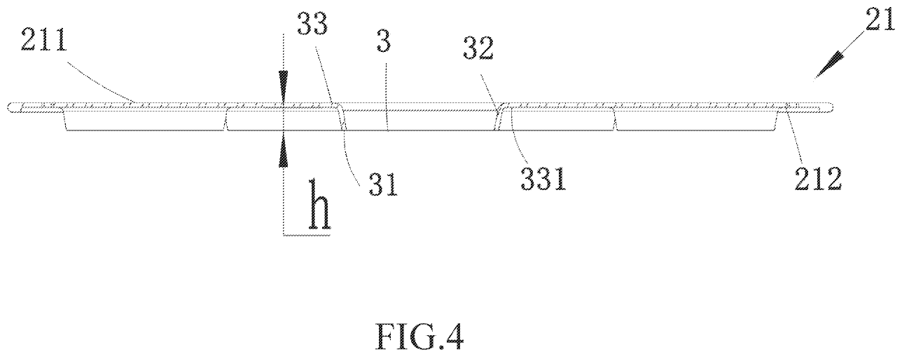

Referring to FIG. 4, in a preferred embodiment, the hollow column 3 of the releasing frame 21 is a hollow truncated cone structure, or may be a hollow truncated pyramid structure. Those skilled in the art can specifically design the releasing frame 21 according to specific needs of the cooking container 22, and the structure of the hollow column 3 is not limited to the two structures disclosed in this embodiment.

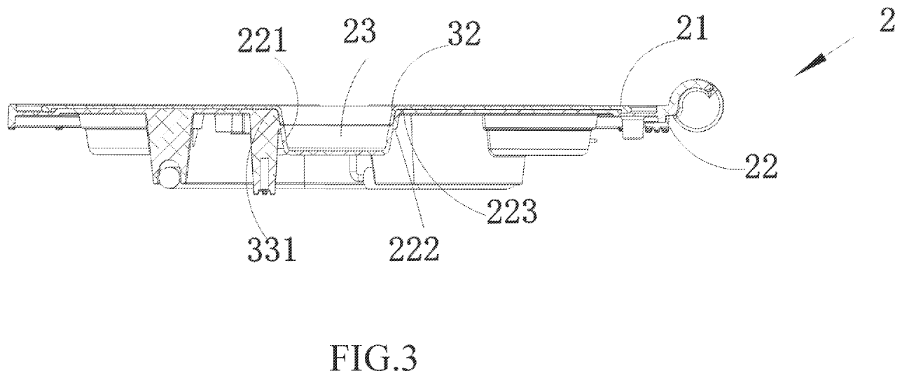

Referring to FIG. 3, in a preferred embodiment, the abutted portion 222 of the cooking container 22 is a recess that is matched with the column sidewall 32 of the hollow column 3, and when the releasing frame 21 abuts the abutted portion 222, the column sidewall 32 of the hollow column 3 is smoothly connected to the container sidewall 221 of the cooking container 22 so that a shape of the cooked food 5 is not changed by placing the releasing frame 21 in the cooking container 22.

Referring to FIGS. 1 to 9, in a preferred embodiment, the height of the hollow column 3 is h, a depth of the cooking container is A, and an optimal range of h is ⅓A≤h≤⅔A. Through the height h of the hollow column 3, the user is enabled to lift the releasing frame 21 that holds the cooked food 5. The releasing frame 21 will not cause the cooked food 5 to fall due to the height h of hollow column 3 being too low to bear the cooked food 5, and the releasing frame 21 will not cause the cooked food 5 to easily separate due to the height h of hollow column 3 being too high so as to cause a bottommost part of the releasing frame 21 to be too close to the bottommost part of the cooked food 5 when pressing down the releasing frame 21 to carry out the separation between the cooked food 5 and releasing frame 21. Of course, if a volume of the cooked food 5 is too small, the height h of the hollow column 3 may be smaller than ⅓A, and those skilled in the art may design the height h of the hollow column 3 according to specific needs.

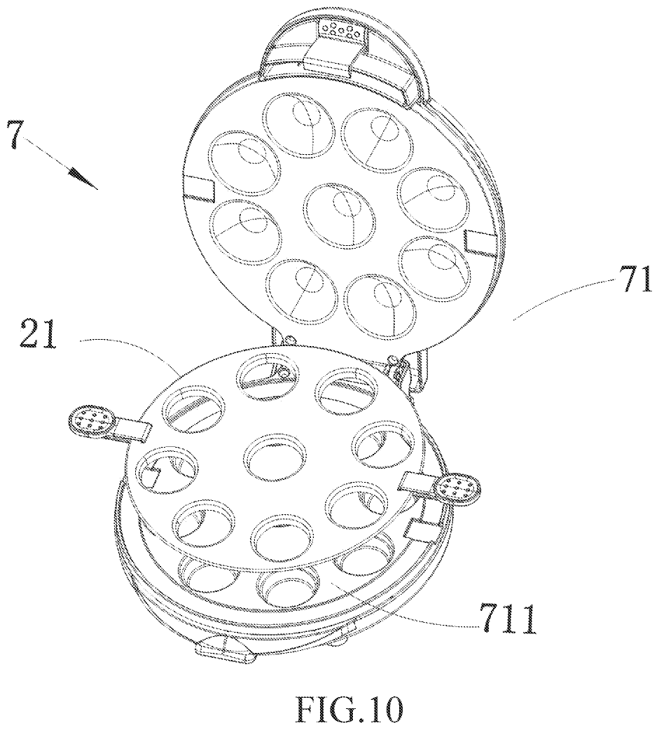

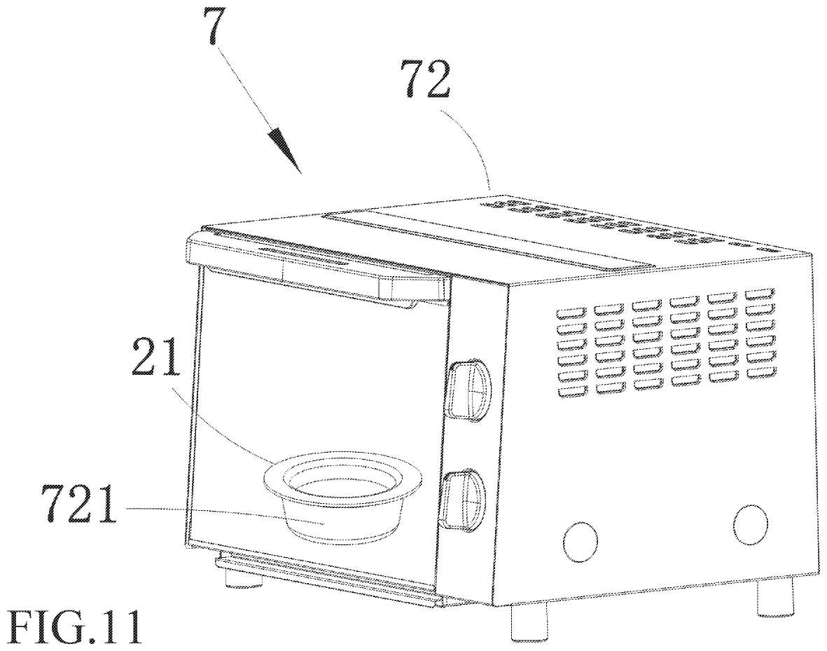

Referring to FIGS. 10 and 11, an embodiment of the present disclosure further provides a cooking device 7, comprising the demoulding device of any of the above embodiments.

Referring to FIG. 10, in a preferred embodiment, the cooking device 7 is a frying and roasting device 71, and the cooking container 22 is a frying and roasting tray 711. The frying and roasting device 71 is a well-known technology for those skilled in the art, and thus will not be described in detail.

Referring to FIG. 11, in a preferred embodiment, the cooking device 7 is a baking device 72, and in particular, may be an oven, and the cooking container 22 is a baking pan or a baking-dedicated container 721. The baking device 72 is well known to those skilled in the art, and will not be described in detail.

In summary, the releasing frame 21 abuts the abutted portion 222 of the cooking container 22, the bottommost part of the releasing frame 21 is higher than the bottommost part of the cooking container 22. When the releasing frame 21 and the cooked food 5 are taken out from the cooking container 22 and placed on the plane, the bottommost part of the releasing frame 21 is higher than the bottommost part of the cooked food 5, and the releasing frame 21 is pressed down slightly, so that the releasing frame 21 can be separated from the cooked food 5, and the purpose of the disclosure can be achieved.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A demoulding device, configured for releasing a cooked food, comprising:
a releasing frame, and
a cooking container, wherein:
the releasing frame comprises a top end, a bottom end, and a hollow column extending downward from the bottom end and penetrating through the releasing frame in a vertical direction,
the cooking container comprises a container sidewall,
the container sidewall comprises an abutted portion which the releasing frame is configured to abut, and
when the releasing frame abuts the abutted portion, a bottommost part of the hollow column is higher than a bottommost part of the cooking container.

2. The demoulding device according to claim 1, wherein:
a cross-sectional area of the hollow column gradually decreases in a direction from the top end of the releasing frame to the bottom end of the releasing frame.

3. The demoulding device according to claim 1, wherein:
a column sidewall of the hollow column is inclined gradually inward from the top end of the releasing frame to the bottom end of the releasing frame.

4. The demoulding device according to claim 1, wherein:
the hollow column has a flange extending outward from a column sidewall of the hollow column at the top end.

5. The demoulding device according to claim 1, wherein:
the releasing frame has a handle.

6. The demoulding device according to claim 4, wherein:
a bottom surface of the flange is configured to abut a top wall of the cooking container.

7. The demoulding device according to claim 2, wherein:
the hollow column of the releasing frame is a hollow truncated cone structure.

8. The demoulding device according to claim 1, wherein:
the abutted portion of the cooking container is a recess.

9. The demoulding device according to claim 1, wherein:
a height of the hollow column is h,
a depth of the cooking container is A, and
a range of h is ⅓A≤h≤⅔A.

10. A cooking device, comprising the demoulding device according to claim 1, wherein:
the cooking container is a frying and roasting tray.

11. The demoulding device according to claim 3, wherein:
the hollow column of the releasing frame is a hollow truncated cone structure.

12. The demoulding device according to claim 1, wherein:
a height of the hollow column is h,
a depth of the cooking container is A, and
the height h of the hollow column is smaller than ⅓A.

13. The cooking device according to claim 10, wherein:
a cross-sectional area of the hollow column gradually decreases in a direction from the top end of the releasing frame to the bottom end of the releasing frame.

14. The cooking device according to claim 10, wherein:
a column sidewall of the hollow column is inclined gradually inward from the top end of the releasing frame to the bottom end of the releasing frame.

15. The cooking device according to claim 10, wherein:
the hollow column has a flange extending outward from a column sidewall of the hollow column at the top end.

16. The cooking device according to claim 10, wherein:
the releasing frame has a handle.

17. The cooking device according to claim 15, wherein:
a bottom surface of the flange is configured to abut a top wall of the cooking container.

18. The cooking device according to claim 13, wherein:
the hollow column of the releasing frame is a hollow truncated cone structure.

19. The cooking device according to claim 10, wherein:
the abutted portion of the cooking container is a recess.

20. The cooking device according to claim 10, wherein:
a height of the hollow column is h,
a depth of the cooking container is A, and
a range of h is ⅓A≤h≤⅔A.
